(19) United States
(12) Patent Application Publication
(10) Pub. No.: US 2013/0254181 A1
(43) Pub. Date: Sep. 26, 2013

(54) Aggregation and Categorization

(71) Applicant: Be Labs, LLC, Seattle, WA (US)

(72) Inventors: Edward Balassanian, Seattle, WA (US); Scott W. Bradley, Kirkland, WA (US); Guy Carpenter, Atherton (AU)

(21) Appl. No.: 13/733,822

(22) Filed: Jan. 3, 2013

Related U.S. Application Data
(60) Provisional application No. 61/582,764, filed on Jan. 3, 2012.

(51) Int. Cl. G06F 17/30

(52) U.S. Cl. CPC G06F 17/30864
USPC 707/709

(57) ABSTRACT

Disclosed is a computer-implemented method to aggregate products from online stores, the method comprising crawling one or more websites associated with one or more online stores; collecting information pertaining to products of the stores; extracting key data about each product; and classifying the products into one or more categories based on the key data.

### RELATED APPLICATIONS

This patent claims the benefit of and priority to U.S. Provisional Application No. 61/582,764 filed on Jan. 3, 2012, the disclosure of which is hereby incorporated by reference in its entirety for all purposes.

### SUMMARY WITH BACKGROUND INFORMATION

Online aggregators operate by gathering goods and services from one or more websites, and providing a single interface for users to find the aggregated goods and services. Often online aggregators do not maintain inventory. Rather, aggregators make money by sending users to one or more affiliate websites to complete the purchase of a good or service. Online revenue models based on Cost per Click (CPC), Cost per Mille (CPM) and Cost per Action (CPA) are well known to those skilled in the art.

Web Crawlers and their use are well known in the art. Briefly, a crawler visits a website via a URL (Uniform Resource Locator), finds all the hyperlinks on that website and adds them to a list. Further, the Crawler can be Configured to search each page associated with a hyperlink for additional hyperlinks. Upon Completion the Crawler stores all the discovered URLs into a file.

Web Scrapers and their use are well known in the art. Briefly, web scrapers collect information from web pages. Scrapers operate by extracting data from within one or more individual web pages. Commonly, regardless of now the data is extracted, it is normalized for storage in a unified format.

Current Solutions fail to properly normalize data extracted from two or more online Stores. Specifically, the product web pages of two different online Stores often contain different descriptors for the same product. Further, product pages from the same vendor often have different descriptors or, in some cases, there are similar descriptors for different versions of a product.

A Solution that automatically normalizes product data while taking into account variations between descriptive data from a plurality of Online Stores has eluded those Skilled in the art, until now.

A solution that utilizes a Configurable rules engine to normalize and classify aggregated data has eluded those skilled in the art, until now.

It would be advantageous to provide a system that automatically collects and normalizes products from a plurality of online stores.

It would also be advantageous to provide a System that performs normalization through a Configurable rules System utilizing a defined taxonomy of terms.

It would also be advantageous to provide a System that enables human intervention to improve the normalization, taxonomy and Classification processes.

It would also be advantageous to provide a system that automatically generates a human usable browse tree to navigate the aggregated products via a web page.

The present disclosure relates to a service provided on a computer network. The service may aggregate products from one or more online stores. In one embodiment, a system crawls (i.e., accesses and extracts data from) one or more websites associated with one or more online stores and collects information pertaining to those stores' products. The system extracts key data about each product and classifies the products into one or more categories. The system displays the products in a user interface for an individual.

One or more individuals (or entities, groups, or any other potential users of the service) may access the system. Such parties are referred to herein as “users”. A user may also be an administrator for the System.

In one embodiment, an online shopping aggregator may gather data relating to products from a plurality of websites and present the data to users via a website. The website may direct a user to a third party site that allows the user to purchase one or more products. As used herein, “product” may refer to a good or a service.

Further, the aggregation process may normalize the data that have been aggregated from one or more websites. This is especially important when the same product is being sold on two different merchant websites that have different descriptive information for the Same product, as well as different product identification, different product numbers or even different product names.

The data may be automatically aggregated, normalized, Classified and presented to a user in a unified manner.

### BRIEF DESCRIPTION OF THE DRAWINGS

FIG. 1 is an illustration of one embodiment of the system and its components;

FIG. 2 is an illustration of one embodiment of the System and third party websites;

FIG. 3 is a flow chart detailing one embodiment of a process for extracting product data from one or more third party websites;

FIG. 4 is a flow chart detailing one embodiment of a process for classifying the data;

FIG. 5 is a flow chart detailing one embodiment of a process for Comparing data for alerts;

FIG. 6 is a flow chart detailing one embodiment of a system for merging data files;

FIGS. 7A and 7B are illustrations of one embodiment of a user interface browse tree;

FIG. 8 is an illustration of one embodiment of a new merchandise alert;

FIG. 9 is an illustration of one embodiment of a web page for setting an alert based on a specific item of merchandise;

FIG. 10 is an illustration of one embodiment of an alert management webpage;

FIG. 11 is an illustration of one embodiment of an availability alert; and

FIG. 12 is an illustration of one embodiment of a price change alert.

### DETAILED DESCRIPTION

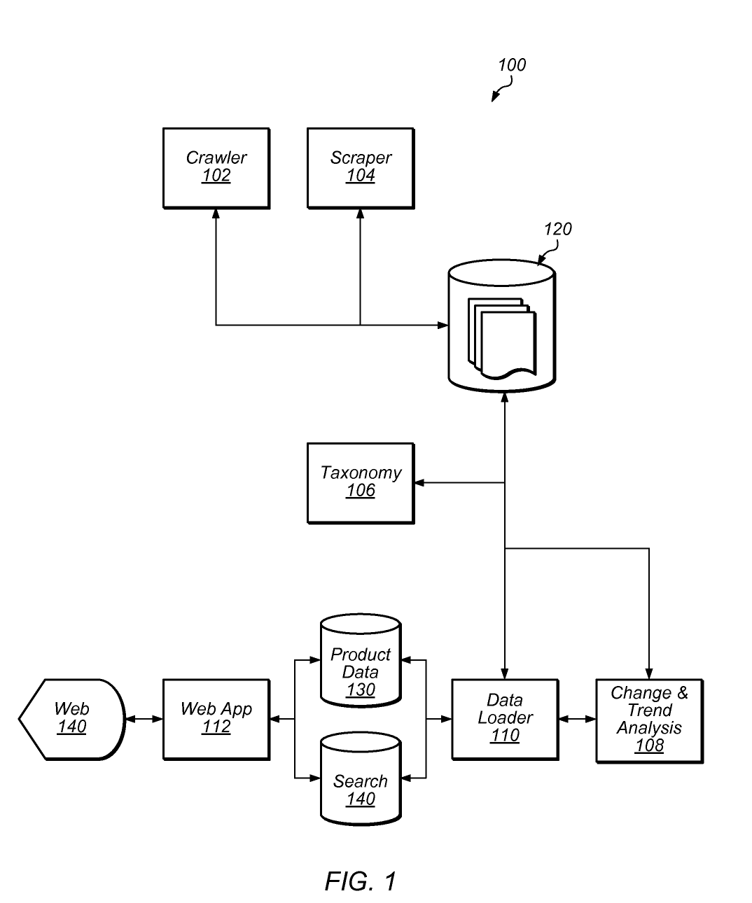

FIG. 1 is an illustration of the components that comprise one embodiment of the system described in detail below. Unless indicated otherwise, all functions described herein may be performed in either hardware, software, firmware, or some combination thereof. In some embodiments the functions may be performed by a processor, such as a computer or an electronic data processor, in accordance with code, such as computer program code, software, and/or integrated circuits that are coded to perform such functions. Those skilled in the art will recognize that software, including computer-executable instructions, for implementing the functionalities of the present invention may be stored on a variety of computer readable media including hard drives, compact disks, digital video disks, computer servers, integrated memory storage devices and the like.

Any combination of data storage devices, including without limitation computer servers, using any combination of programming languages and operating systems that support network connections, is contemplated for use in the present inventive method and system. The inventive method and system are also contemplated for use with any Communication network, and with any method or technology, which may be used to communicate with said network. It is contemplated that the present inventive system and method may be used in connection with an e-commerce, discount or coupon platform and service as described in co-pending provisional 61/564,992 “SYSTEM AND METHOD FOR DISCOUNT PURCHASES” filed Nov. 30, 2011.

In the illustrated embodiment, the Components of system 100 are resident on a Computer server; however, those Components may be located on one or more Computer servers, virtual or Cloud Computing services, one or more user devices (such as one or more smart phones, laptops, tablet Computers, and the like), any other hardware, Software, and/or firmware, or any combination thereof. The System 100 is also referred to as the Strings System.

The System 100 includes a crawler component 102. In one embodiment the crawler component 102 may be Configured to Crawl one or more web Sites, generating a Series of URL's (Uniform Resource Locator) for a Scraper 104 to process. The Crawler component 102 may encode an array of items to be scraped. The array of items may be written to one or more crawler data files created by the crawler, and Stored in a data Store 120. Each item is a URL. Web Crawlers are well known to those skilled in the art.

Further, additional metadata can be associated with each URL. The metadata can be used by other Components within the System, for example the Scraper and taxonomy Components.

Further, the Crawler Can be Configured to Create and Store an individual crawler data file for each URL (item). Alternatively, any number of Crawler data files Can Contain any number of URLS, or all URLS crawled for a Specific merchant website can be Stored in a Single Crawler data file.

It is contemplated that the one or more Crawler data files do not need to be Created every time the present inventive System and method is used. The Crawler may load one or more previously Created Crawler data files and append or update accordingly.

In an alternative embodiment the Crawler 102 may not Create a Crawler data file, rather the Crawler may be Configured to Store items and metadata directly in a database or other data Store 120, as described in detail below.

The Scraper Component 104 may be responsible for extracting the data from one or more URL'S provided in the one or more Crawler data files. The Scraper Component loads the one or more Crawler data files, as described above, and for each URL in the one or more crawler data files, the Scraper extracts the relevant data. The extracted data is then Stored in one or more Scraper data files. Web Scrapers are well known to those skilled in the art.

In a preferred embodiment, scraper data files are stored using the naming convention “product_id.merchant”. In this embodiment, the product ID is extracted from the merchant web site by the scraping component (i.e., the scraper data file illustrated below uses the product ID “alb2c3” taken from the merchant web Site). Alternatively, the product ID used in connection with the Scraper data file may be different from the merchant product ID extracted from the merchant web site. In this alternative embodiment, the product ID used in connection with the scraper data file may correspond to the merchant product ID from the merchant web site, and the correspondence between the product ID and merchant product ID may be shown in a lookup table or other Suitable method.

Below is one example of the data that Could be stored in a “.merchant” file:

| Filename: a1b2c3.merchant | |
|---|---|
| { | |
| “product id” | : “alb2c3”, |
| “merchant” | : “onlinestore” |
| “name” | : “Furry Boots” |
| “Brand” | : “Winter Wear Co.” |
| “MSRP” | : “$1,114.99” |
| “Colors” | : “black, brown, grey” |
| “Icon URL” | : “http://onlinestore.com/images/001.png” |
| “URL” | : http://onlinestore.com/product/boot.html |
| } | |

In a further embodiment, the scraper component may be Configured to scrape only the web pages that have Changed since the last time the merchant website was scraped. For example, the scraper can send a HTTP GET request to a specific URL, and if it receives a response of 304 ‘Not Modified’, it may skip scraping that Specific web page.

In a preferred embodiment, the Crawler data files and Scraper data files Created and Stored by the Crawler and Scraper Components are of the JSON (JavaScript Object Notation) file type. However, the format of the Crawler data files and Scraper data files is not limited to a specific format, and can be any public or proprietary format. Further the names of the Crawler data files and Scraper data files can be any names and are not limited to the example product.merchant format.

The data store 120 can be any relational database or flat file system. In a preferred embodiment, the data store is a version Control data repository. A version Control repository can be any one of GIT, CVS, Subversion or other. Version Control repositories, their use, and benefits are well known to those skilled in the art.

The taxonomy component lO6 may be configured to further classify the data captured from the scraping process. As discussed in detail below, the taxonomy component may create one or more taxonomy data files resulting from the classification process. The taxonomy component may store the one or more taxonomy data files in the data store 120.

The change and trend analysis component 108 may be configured to compare current product data, after processing by the scraper and taxonomy components, to product data previously collected by the system. Change analysis can be configured to extract changes in price, availability, colors, sizes or other product specific related data. Both the previous value and new value may be Stored. Trend analysis may be performed over a specific period of time on one or more products. The results of the trend analysis may be Stored in data Store 120.

The data loader 110 may be configured to read the product data files from the data store l2O and merge them with previously existing product data files. As used herein, “product data files” means one or more of the following: crawler data files, scraper data files, and/or taxonomy data files (including without limitation altered taxonomy data files produced by human intervention as discussed below). The merging algorithm, described in detail below, may orderly combine each file outputted by the scraper and taxonomy components for each product, as the sum of all the scraper data files and taxonomy data files based on the taxonomy process.

Once all product data files are merged, the data loader llO may Store the merged and updated product data (i.e., the data resulting from the merging of two or more product data files) in a database l3O and make the product data searchable via a Search platform 140.

The database l3O can be any relational database, (i.e. MySQL). Relational databases and their use are well known to those Skilled in the art.

The search platform can be any search platform designed to index the product data stored in the database to support high-speed searching (i.e. Solr). Search platforms and their use are well known to those Skilled in the art.

The system may contain a web interface component 114 configured to receive input from multiple types of input sources and to display one or more web pages. For example, the input and web page display can occur through a browser executing on a personal computer or a mobile device. In one embodiment, the web interface component 114 may interact with the web application (“web app”) 112. The web application is configured to display one or more web pages relating to one or more products based on user action. A user action directing the web app to display one or more web pages can be a response to the user's performance of at least one of the following actions: local search, third party search (Google, Yahoo) or web page browsing.

In a further embodiment, the System may also Contain a user database and management Component.

In alternative embodiments, any or all of the Components of the System described above may be Combined into one or more Components.

In a further alternative embodiment, Components may reside on Separate Systems or in any of the Configurations as described above.

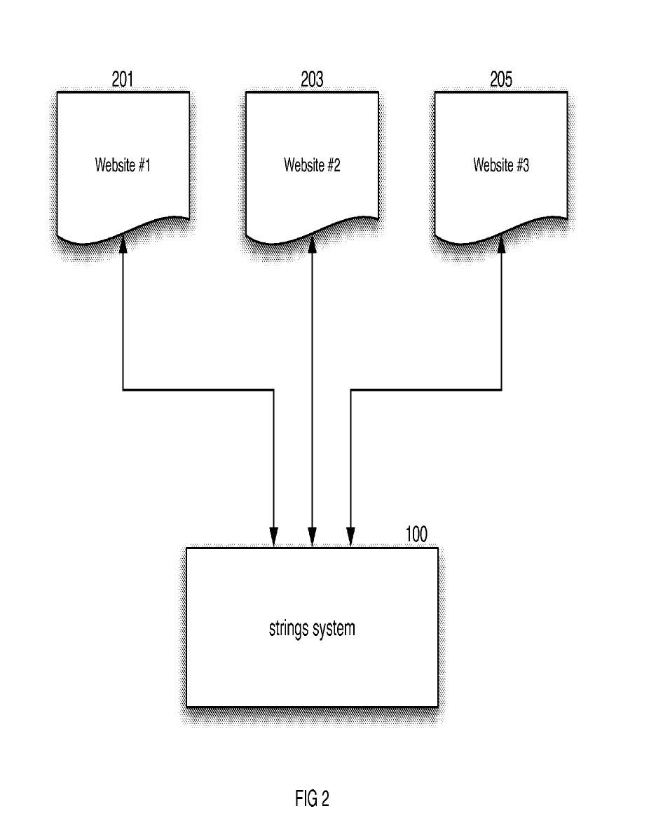

FIG. 2 is an illustration of one embodiment of the system 100 and third party websites. For purposes of simplicity there are three websites illustrated, 201, 203, and 205 respectively. However, the present invention has no limitation on the number of websites that Can access the strings System 100. Third party websites Can comprise any e-commerce websites the Strings System is Configured to Crawl and scrape.

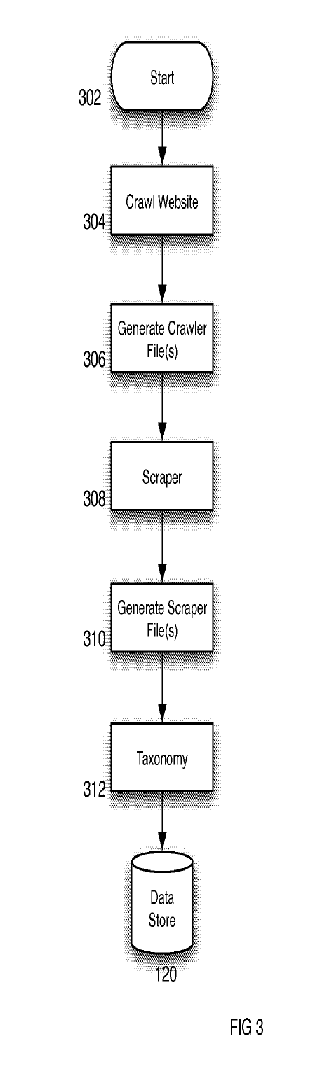

FIG. 3 is a flow chart detailing one embodiment of a process for capturing and classifying data from the web. In the illustrated embodiment, the process begins 302 based on a pre-configured time interval. Alternatively, a system administrator may initiate the process. Next, the process crawls 304 one or more websites as instructed by the system. The websites the crawler is instructed to crawl can be stored in a file or provided at the time the process begins. Next, the crawler extracts the URL's for one or more web pages corresponding to one or more products and generates a crawler data file 306 for use by the scraper. The crawler data file is stored in the data store l20. Next, the scraper uses the crawler data file 308 to scrape each URL previously identified by the crawler. The scraper generates one or more scraper data files 310, each such file representing one or more products from a given merchant. In this embodiment, the scraper stores the one or more scraper data files in the data store 120. As discussed above the product ID in the product.merchant file notation may correlate directly to the merchant product ID from a given online merchant website. In step 312 the taxonomy component loads each product.mercnant file created by the scraping process. The taxonomy process is discussed in detail below. Once the taxonomy process is complete, in step 320 the taxonomy data files are Stored in the data Store 120.

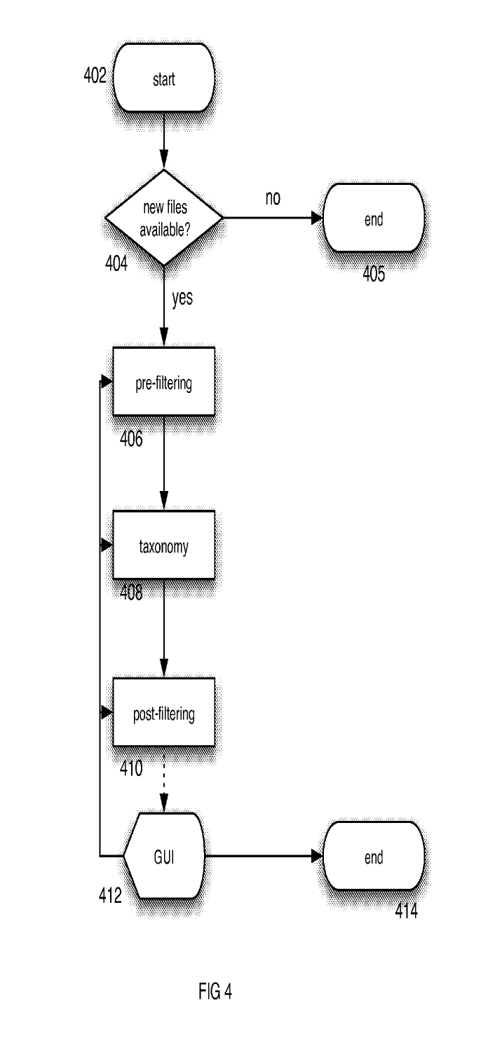

FIG. 4 is a flow chart detailing one embodiment of a process for classifying online merchant product data. The process begins 402 based on (without limitation) one of the following: a pre-configured timer, system administrator instructing the system, or the scraper instructing to start the classification process once scraping is complete. Next, the process determines if new Scraper data files are available 404. If not, then the process ends 405. If yes, the scraper data files are pre-filtered based on a set of pre-configured criteria 406. For example, pre-filtering can be checking the brand of each product.merchant file with that of a blacklist. A blacklist comprises a list of one or more undesired attributes. In this example, if a product.mercnant file nas an attribute matching a brand not allowed (i.e., a brand on the blacklist), tnen the file will be discarded and not processed any further. Blacklist filtering can be on any one of the following (without limitation): brand, merchant, product category, price, color or any other attribute extracted by the scraper. Next, the data is processed through a taxonomy step. In this embodiment, the taxonomy step 408 comprises tagging for classification into a defined taxonomy of terms. For example terms may comprise (without limitation); men, women, children, shirt, dress, jacket, shoe, or any other descriptive term that can identify what category the product would belong to. Further, terms used in tagging can include the vendor, style, and subcategory of the product. In one embodiment, the taxonomy process is accomplished through the utilization of rules configured to identify keywords and match those keywords to one or more terms. Further, the taxonomy step may determine the category of a product, without keywords. This determination may be done through rules Configured to perform a “is a” “has a” relationship on the data within a product file. For example, for a product.merchant file with a name value of “Bacon Blazer” rules could be configured to examine the values separately at first, then together second. The rules could identify the word “Bacon” and classify that as food, and the term “Blazer” and classify that as clothing. With rules, the system knows that the product “Bacon Blazer” (determined when the values are examined together) is clothing with a descriptor of “bacon”; therefore, the product would be tagged as “Blazer” and further could be tagged as “men's” or another term that was appropriate for the product.

```
Filename: a1b2c3.algorithm
{
    TAGS: [
        “mens”,
        “blazer”,
        “humor” ]
}
```

The above example (Filename: alb2C3.algorithm) Shows one embodiment of how the taxonomy and Classification process may Create a product.algorithm file that may be Stored in the data Store 120.

After the taxonomy step 408, the newly Created taxonomy data file may be analyzed in postfiltering step 4lO. The post filtering of data performs analysis of the data such as, but not limited to, checking for spelling errors, additional blacklisting or additional tagging and Classification. Any updates Can be Stored in the data Store 120. The data Can be Stored as a modified .algorithm file or a Separate data file.

Next, the process may allow for human intervention via a graphic user interface (“GUl”) 412 to Confirm and modify the data. If an individual alters the data, a product.human file, illustrated below, is created to store the altered taxonomy data file. The altered taxonomy data file may be stored in the data Store 120.

```
Filename: a1b2c3.human
{
      “mens” : “D&G
      “colors” : [“Red”, “Green”, “Yellow”]
}
```

The above example (Filename: alb2o3.human) snows one embodiment of now the human intervention process may Create a product.human file that may be Stored in the data Store 120.

In a further embodiment, at step 412 the individual verifying the data can update the rules for use in the taxonomy step 408. The taxonomy and classification process may then use the new rules for future processing. Even further, the current data can be reprocessed to ensure the updated rules are Operating properly.

Even further, the process can be parallelized to support the processing of any number of scraper files at once or in batches.

In an alternative embodiment, the files are not Stored Separately; rather a Single file is overwritten each time.

In this embodiment, after the individual completes the human intervention step 412, the process ends 414. It is contemplated that any or all steps discussed herein in connection with any process may involve interaction with data Store 120 as necessary or desirable to Store any and all data used in Connection with the present disclosure.

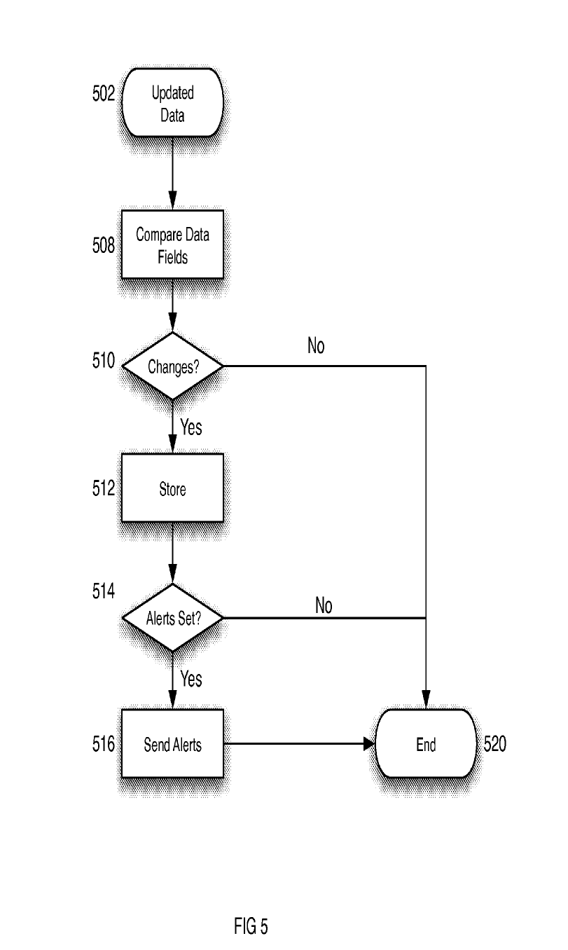

FIG. 5 is a flow chart detailing one embodiment of a process for change analysis and alerts. The process begins 502 when new product data files have been put into the data store 120.

In an alternative embodiment, the process described in FIG. 5 may apply to product data in database 130—i.e., instead of product data files, the process may work with product data, and instead of data store 120 the process may work with database 130. As described above, the product data is a collection of information about one or more products and can be stored in either a file format or within a database.

In step 508, the process compares the new product data files with old product data files that were previously stored in data store 120. In an example embodiment, the system can be configured, through administrator created comparison rules, to compare all the data within the old product data files and new product data files. Alternatively, the system may compare a subset of the data values within the old product data files and new product data files. For example, a Comparison Rule can be created to compare only the price of each product by comparing the old product data files and new product data files. Another example is size availability or color. The comparison can detect if Sizes are newly available or no longer available, or if the available colors have changed. If there are no changes 5lO, then the process ends 520. Otherwise, if there are changes between the old product data files and the new product data files, then the change data is stored 512. The change data stored in relation to a particular product can include (without limitation) the product price change, inventory availability Changes, or details about inventory (i.e. sizes, Color, etc.). In step 514, the system Checks to see if there are any alerts set based on one or more products. If no alerts are set then the process ends 520. If alerts are set, then the specific alerts are sent to the one or more users that requested an alert based on specific Change Criteria 516. The process ends 520.

A user may set alerts on any products and product related data Captured and Subsequently Stored by the System. For example, and without limitation, alerts can be Set on Specific products relating to availability (size and color) or price changes (sale). Further, alerts can be set for specific product manufacturers (designers), new products from a manufacturer (designer), or Changes within a specific product Category (i.e. men's jackets).

Further, alerts can be integrated into the instant rebate system as described in detail in U.S. provisional patent application No. 61/564,992. When a price changes on a specific item, the alert system can provide a user with the option of purchasing an instant discount along with the price Change alert.

Further, the system can be configured to perform trend analysis based on the stored data. For example, and without limitation, the trend analysis can be Configured to analyze the specific trends of a product, online merchant, a group or type of products, or one or more designers. For example, trend analysis on bath suits could determine that online retailers place summer clothing, including bathing suits, on sale in the month of October each year. Trend data can be stored and used by other components of the system. For example, the instant rebate system, as referenced above, can utilize trend analysis to inform users of potential future changes in product prices, inventory availability based on one or more merchants, or seasonal inventory changes. When a user purchases an instant rebate of a given product, the system can inform the user that based on historically relevant data the price is likely to be reduced within in the next 30 days. Potential Changes may be determined based on the historical trends and probability of repeating the historical trend.

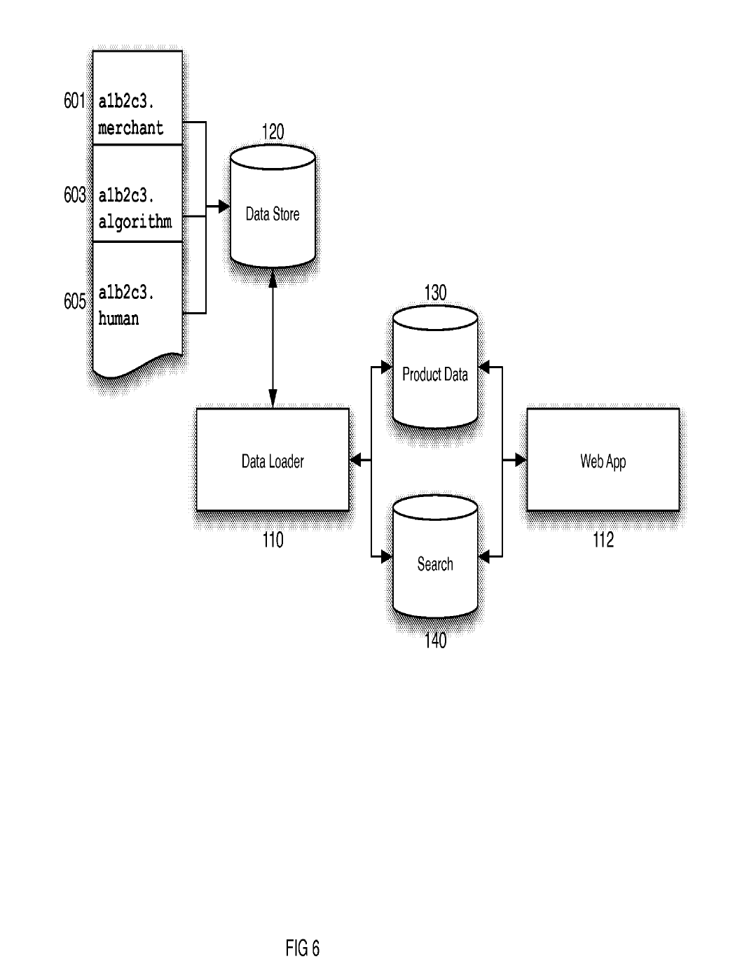

FIG. 6 is a flow chart detailing one embodiment of a system for merging data files. As discussed above, the crawler, scraper, and taxonomy components can each produce their own files, respectively known as crawler data files, scraper data files, and taxonomy data files. Further, an individual may alter the taxonomy data files via a GUI. In this process one or more of those individual files are merged into one or more product data files. File 601 is a first file generated by the scraper process for a specific product, alb2c3.merchant. File 602 is a second file generated for the Specific product by the tagging and taxonomy process, alb2o3.algorithm. The third file 605 is a third file generated for the Specific product by human correction of a taxonomy data file, alb2o3.human. These files are Stored in the data Store 120, and loaded by the data loader llO, in sequential order. In this embodiment, the data loader llO is configured to perform several functions. The data loader merges the files described above to ensure all data for a given product is correct. For example, the .merchant file may be loaded first, and next the .algorithm. The data loader may Compare the fields within each file. If the .algorithm file has additional information for the tagging and classification, the Scraper data file (with data taken directly from the merchant) may be merged with the taxonomy data file for the Specific product. Further, if the .algorithm file has newer data for a given attribute, then data relating to that attribute may be updated and the old information may be either discarded or amended. Next, the process loads the .human file (created by the individual's alteration of the taxonomy data file) and continues to amend or modify values based on new or updated values. The resulting product data are stored in the database 130 and made searchable by the Search platform Component 140.

In an alternative embodiment the system can load data directly from a database or single file rather than from a plurality of files. Further, the data loader can read in a file, write the information to a database and then update the database information by adding or modifying each database value based on the data files subsequently processed.

The web app 112 may be Configured to generate a browse tree based on the data loaded into the database 130 from the data loader 110. The browse tree may utilize the information in the database related to one or more products that was generated during the taxonomy process to automatically Create a grouping of products and categories based on the product data stored in the database. Examples of one embodiment of a browse tree are illustrated below. For example, a browse tree may be an automatically generated structure wherein “Men” is a parent category and “Pants” and “Shorts” for men are subcategories of “Men”, Further, if multiple product types exist for men then “Pants” and “Shorts” Could be subcategories of “Clothing”. The browse tree may be generated by the web app for display to users to navigate the aggregated and Classified product data on a website.

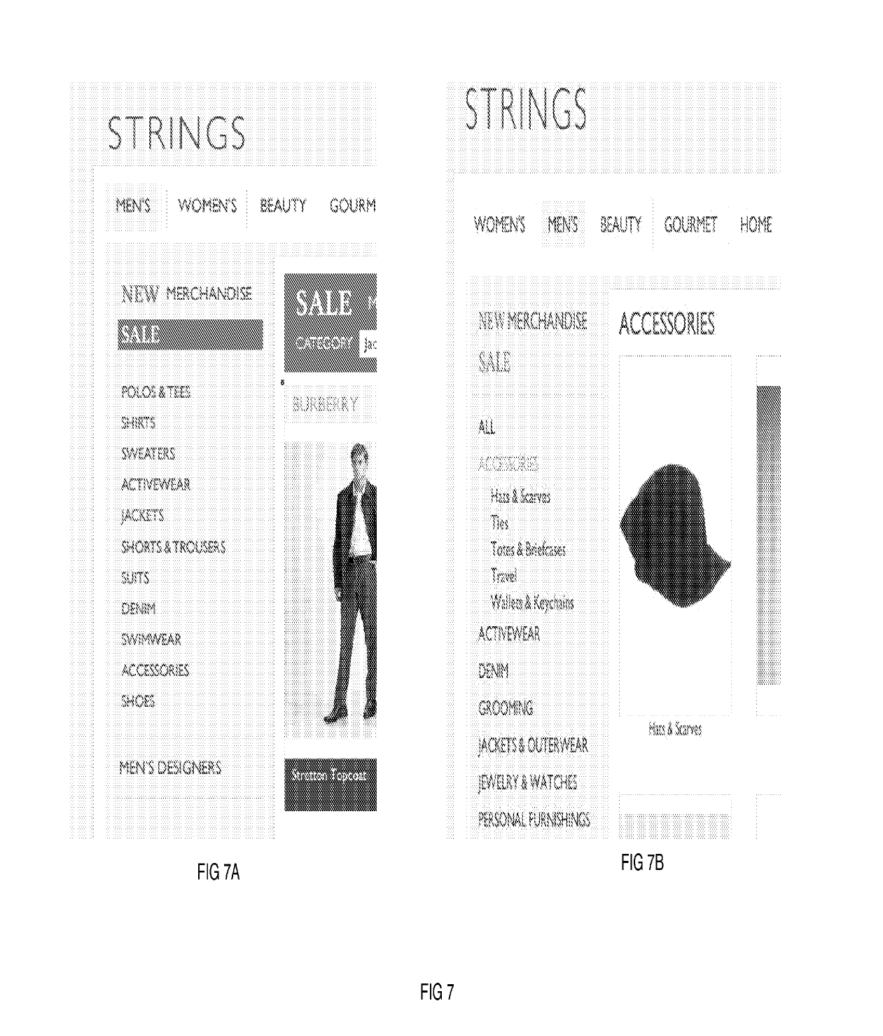

FIG. 7 is an illustration of one embodiment of a browse tree resulting from the data merge process discussed above. FIG. 7A illustrates parent node or category of products. FIG. 7B illustrates subnodes or subcategories of products within a specific Category (“accessories”).

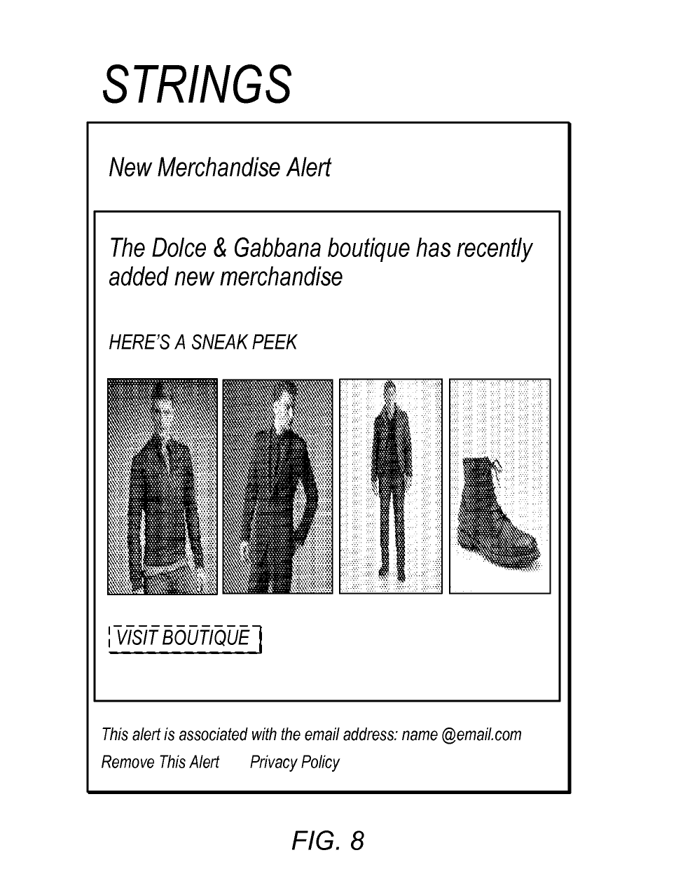

FIG. 8 is an illustration of one embodiment of a new merchandise alert. As discussed above users can set and receive alerts based on a specific designer. In this illustration a user has received an alert for new products from Dolce & Gabbana. One or more new product items are displayed with the alert. The items displayed can be different depending on whether the alert was Set by a male or female.

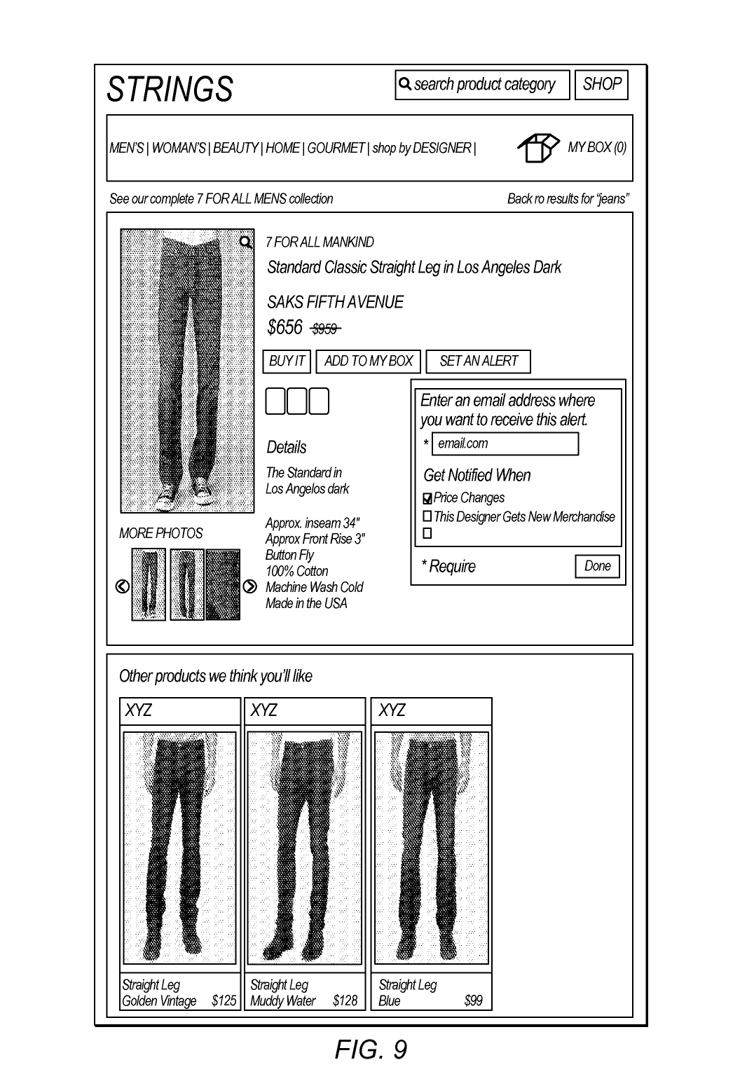

FIG. 9 is an illustration of one embodiment of a webpage for setting an alert based on a specific item of merchandise. In this illustration the user has selected to be notified when the price is reduced from the current price. As discussed above, the user may receive an alert when it is determined that the item has Changed in price.

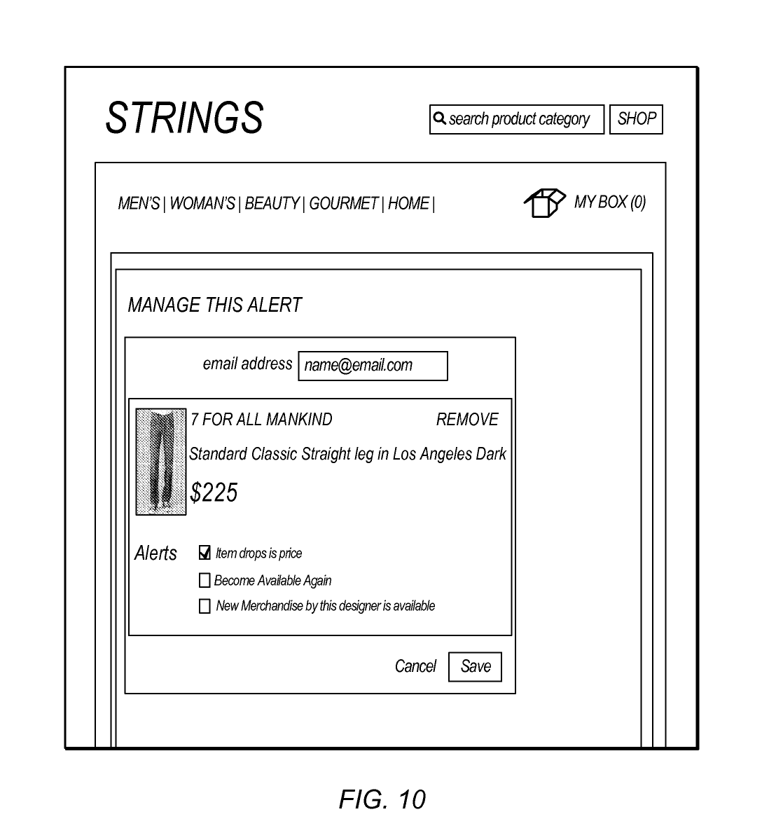

FIG. 10 is an illustration of one embodiment of an alert management webpage. In this illustration the user can manage the conditions under which the user will receive an alert (including without limitation deleting one or more alerts if the user no longer wishes to receive those particular alerts regarding one or more Selected items).

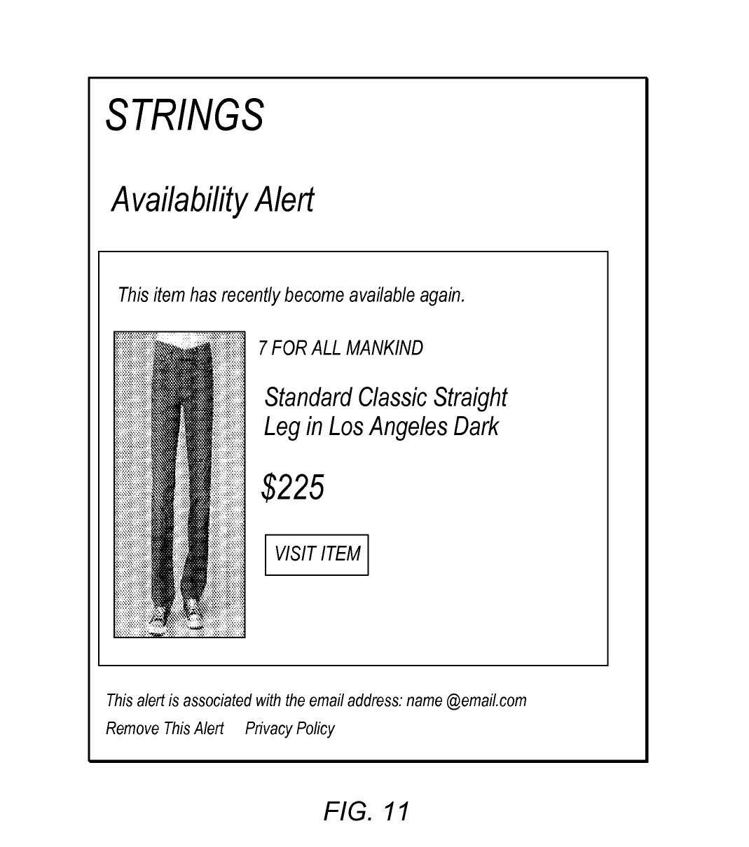

FIG. 11 is an illustration of one embodiment of an availability alert. As discussed above a user Can set an alert on specific items that might be out of stock. The alert may notify the user when an item is available in stock. The alert can be delivered to a user via email or a website.

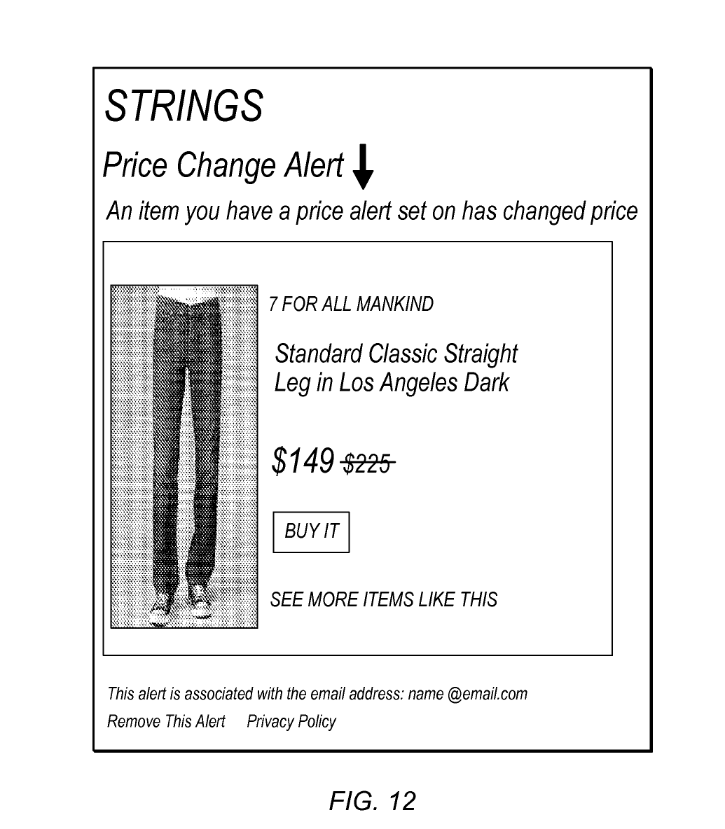

FIG. 12 is an illustration of one embodiment of a price change alert. As discussed above a user can set an alert to be notified when the price of a selected item has been reduced. The alert can be delivered to a user via email or a website.

Thus, in summary, it can be seen that what is described in this disclosure is a system for aggregating, classifying, normalizing and presenting data corresponding with one or more products from one or more online merchants. Further, users can receive alerts and notifications based on data related to the one or more products.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

The invention is:

1. A computer-implemented method to aggregate products from online stores, the method comprising:
crawling one or more websites associated with one or more online stores;
collecting information pertaining to products of the stores;
extracting key data about each product; and
classifying the products into one or more categories based on the key data.

2. The method recited in claim 1, further comprising displaying the products in a user interface.

3. The method recited in claim 1, wherein crawling the websites comprises accessing and extracting data from the websites.
